(19) United States
(12) Patent Application Publication
(10) Pub. No.: US 2008/0038524 A1
(43) Pub. Date: Feb. 14, 2008

(54) Selective Doping of a Material

(75) Inventors: Markku Rajala, Vantaa (FI); Matti Putkonen, Espoo (FI); Joe Pimenoff, Helsinki (FI); Lauri S. Niinisto, Vantaa (FI); Jani Paivasaari, Espoo (FI); Jouko Kurki, Helsinki (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 11/597,357

(22) PCT Filed: Jun. 23, 2005
(86) PCT No.: PCT/FI05/50236

§ 371 Date: Feb. 5, 2007

(30) Foreign Application Priority Data
Jun. 24, 2004 (FI) 20040876

(51) Int. Cl. B05D 3/06; B05C 19/00; C03C 11/00

(52) U.S. Cl. 428/210; 118/624; 427/532; 428/195.1

(57) ABSTRACT

The invention relates to a method of selective doping of a material by a) radiating a predetermined pre-treated pattern/region into the material, b) treating the material for producing reactive groups in the pre-treated pattern/region, and c) doping the material by the atomic layer deposition method for producing a pattern/region doped with a dopant in the material. The invention further relates to a selectively doped material, a system for preparing a selectively doped material, and use of said method.

The invention relates to a method defined in the preamble of claim 1 for selective doping of a material, to a selectively doped material defined in the preamble of claim 14, to a system for preparing a selectively doped material defined in the preamble of claim 27, and to the use according to claim 30.

### PRIOR ART

A doped material is used in the manufacture of various products. A doped porous glass material is employed in the manufacture of an optical waveguide, for example. An optical waveguide refers to an element, an optical fibre, an optical plane waveguide and/or any other similar element, for example, employed for the transfer of optical power.

Various methods are known previously for preparing and doping a material and for changing the characteristics of a material. As examples may be mentioned CVD (Chemical Vapour Deposition), OVD (Outside Vapor Deposition), VAD (Vapor Axial Deposition), MCVD (Modified Chemical Vapor Deposition), PCVD (Plasma Activated Chemical Vapour Deposition), DND (Direct Nanoparticle Deposition) and the sol gel method.

As regards glass materials, it is further previously known that hydrogen is able to produce hydroxyl groups (OH groups) with silicon dioxide. Hydroxyl groups can be added onto the surface of a glass material by treating the glass material with hydrogen at a high temperature, for example. Hydroxyl groups can also be added onto the surface of a glass material by means of a combination of radiation and hydrogen treatment. In this way, Si—H and Si—OH groups are produced on the surface of the glass material.

However, the selective doping of a material by means of a combination of radiation and the atomic layer deposition method (ALD) is not previously known. Consequently, prior art methods do not enable the selective and accurate doping of a material only at predetermined points of the material. Furthermore, for instance the manufacture of an optical waveguide in an actual three-dimensional state has not been possible by means of prior art methods.

The object of the invention is to eliminate the problems of known methods employed for doping a material.

Particularly, the object of the invention is to provide a new, simple and accurate method of selectively doping a material in a manner achieving the formation of a dopant layer only at predetermined points of the material. The object of the method is to provide a method enabling selective modification of a material, thus providing the material with the desired characteristics.

A further object of the invention is to provide a material, accurately and selectively doped in a simple manner, a system for preparing a selectively doped material, and the use of the method for different purposes.

### SUMMARY OF THE INVENTION

The method of the invention for selective doping of a material, the selectively doped material, the system for preparing a selectively doped material, and the use of the method are characterized in what is stated in the claims.

The invention is based on completed research work, which surprisingly showed that predetermined doped patterns/regions can be provided to a material by a method comprising a) first radiating a predetermined pre-treated pattern/region to the material, b) then treating the material for producing reactive groups to the pre-treated pattern/region, and c) finally doping the material by the atomic layer deposition method for producing a pattern/region doped with the desired dopant to the material.

The invention is based on the observation that by radiating so-called pre-treated patterns/regions at predetermined points of the material, considerably more reactive groups required to produce a dopant layer are achieved at these points than in the non-radiated parts of the material. In the ALD method, so-called reactive groups are required in the material, to which groups the dopants can adhere. When the reactive groups are at a given pattern/region, a dopant layer is produced at said point, while the remainder of the material remains non-doped.

A predetermined pattern/region refers to any desired pattern/region, such as a straight line, a curve, a circular or rectangular area, and any other predetermined pattern/region.

To produce a predetermined pre-treated pattern/region by radiation, ionizing radiation and/or non-ionizing radiation can be used. Of ionizing radiation, alpha, beta, gamma, neutron and X-ray radiation can be mentioned as examples. Non-ionizing radiation includes ultraviolet radiation, visible light, infrared radiation, radio-frequency radiation, and low-frequency and static electric and magnetic fields, for example. When a predetermined pattern/region is formed to a material, the intensity of one radiation beam or the intensity of two or more radiation beams has to be controlled at their point of intersection.

After radiation, the material is treated by producing reactive groups to the pre-treated pattern/region.

Reactive groups refer to any groups to which predetermined dopants are able to adhere, i.e. with which groups the dopants react in a manner producing a layer of the desired predetermined dopant. Oxide layers of a predetermined dopant or layers of other compounds may be mentioned as examples. Reactive groups may be OH groups, OR groups (alkoxy groups), SH groups, NH₁₋₄ groups and/or any other groups reactive to dopants.

For producing reactive groups, the material radiated in pre-determined points/regions can be treated with a gaseous and/or liquid substance. In an embodiment, the material is treated with a gas and/or liquid containing hydrogen and/or a hydrogen compound.

After the production of reactive groups, the material is doped by the ALD method using the desired dopant. In other words, the desired dopant layer is grown to the pre-treated patterns/regions of the material.

In the ALD method, the parent substances are led to the substrate one at a time. After each parent substance pulse, the substrate is rinsed with an inert gas, whereby a chemisorbed monolayer of one parent substance remains on the surface. This layer reacts with the following parent substance generating a given partial monolayer of the desired material. The ALD method can be used to determine the thickness of the dopant layer exactly by repeating the cycle the required number of times. In the present invention, the ALD method refers to any conventional ALD method as such and/or any application and/or modification of said method that is evident to a person skilled in the art.

The dopant used in the ALD method may comprise one or more substances comprising a rare earth metal, such as erbium, ytterbium, neodymium and cerium, a substance of the boric group, such as boron and aluminium, a substance of the carbon group, such as germanium, tin and silicon, a substance of the nitrogen group, such as phosphorus, a substance of the fluoric group, such as fluorine, and/or silver and/or any other material suitable for doping. The substance may be in an elemental or compound form.

When a porous glass material is doped by means of the ALD method, the reactive groups are efficiently removed from the material as the dopant reacts with said reactive groups. If need be, the doped material can be purified after the doping by removing any reactive groups and any other impurities possibly remaining therein.

A selectively doped material refers to glass, ceramic, polymer, metal and/or a composite thereof. Ceramics treated in accordance with the invention include Al₂O₃, BeO, MgO, TiO₂, ZrO₂, BaTiO₃, for example. The ceramics treated in accordance with the invention may also be any other known ceramics. As examples of polymers, natural polymers, such as proteins, polysaccharides and rubbers; synthetic polymers, such as thermoplasts and thermosets; and elastomers, such as natural elastomers and synthetic elastomers, may be mentioned. The metals may be any metals, known per se, or mixtures thereof. Al, Be, Zr, Sn, Fe, Cr, Ni, Nb and Co may be mentioned as examples. The metals may also be any other metals or mixtures thereof. In addition to the above, the material may also be a material comprising silicon or a silicon compound. 3 BeO.Al₂O₃.6SiO₂, ZrSiO₄, Ca₃Al₂Si₃O₁₂, Al₂(OH)₂SiO₄ and NaMgB₃Si₆O₂₇(OH)₄ may be mentioned as examples.

In an embodiment, the material is a porous glass material. The glass material may be any conventional oxide producing glass, such as SiO₂, B₂O₃, GeO₂ and P₄O₁₀. The glass material may also be phosphorous glass, fluoride glass, sulphide glass and/or any other similar glass material. The glass material may be partially or entirely doped with one or more substances comprising germanium, phosphorus, fluorine, boron, tin, titan and/or any other similar substance. K—Ba—Al-phosphate, Ca-metaphosphate, 1PbO-1,3P₂O₅, 1PbO-1,5SiO₂, 0,8K₂O-0,2CaO-2,75SiO₂, Li₂O-3B₂O₃, Na₂O-2B₂O₃, K₂O-2B₂O₃, Rb₂O-2B₂O₃, crystal glass, soda glass and borosilicate glass may be mentioned as examples of glass materials.

The porous glass material may be a glass preform, for example, intended to be used in the manufacture of an optical fibre. The porous glass material may also be a porous glass material employed in the manufacture of other optical waveguides, such as for the manufacture of an optical plane waveguide or an optical waveguide to a three-dimensional state.

In an embodiment, radiation is directed from at least two different directions in such manner that the pre-treated pattern is produced in a three-dimensional state to the material. Reactive groups are produced in said pattern, and the pattern, in a three-dimensional state, is doped. In an embodiment, an optical waveguide is produced in a three-dimensional state.

In an embodiment, tension-generating regions are produced in a porous glass preform used in the manufacture of an optical fibre by radiating the glass preform by means of a partially covered radiation source in such a manner that the radiation produces pre-treated regions only at predetermined points of the glass preform and by then producing reactive groups, and finally by growing layers of the desired dopant in said regions.

In an embodiment, a predetermined doped pattern/region is radiated onto a plane surface. In an embodiment, an optical waveguide is produced onto the level.

The method according to the present invention can be used in connection with the manufacture of an optical waveguide, such as an optical fibre, an optical plane waveguide, an optical waveguide in a three-dimensional state or any other similar element, for example.

When the material is selectively doped, said material can be treated further by means of conventional steps, if required. For example, in selective doping of a porous glass material and in the production of optical fibre thereof, said porous glass material can be purified, sintered and drawn into an optical fibre, for example, after the doping. When the material is sintered, the dopants are diffused into the material.

For the manufacture of the selectively doped material according to the present invention, a method can be used, comprising

a radiation source for radiating a predetermined pre-treated pattern/region to the material;

means for treating the material for producing reactive groups to the pre-treated pattern/region of the material, and

an atomic layer deposition device for doping the material with a dopant for producing a doped pattern/region to the material.

The system may comprise one or more sources generating ionizing radiation and/or non-ionizing radiation. For example, the system may comprise two, three, four, etc. radiation sources.

The system may comprise at least two radiation sources for directing the radiation from at least two different directions. When the material is radiated from two or more different directions, the pre-treated pattern/region can be generated to a three-dimensional state to the material.

The means for producing reactive groups comprise any conventional means enabling the treatment of the material with a gaseous and/or liquid substance.

The ALD device employed for growing the dopant layer can be any conventional ALD device and/or an application and/or modification thereof that is evident to a person skilled in the art.

The system may further comprise means and/or devices for further processing the selectively doped material, for purification, sintering, etc., for example.

An advantage of the invention is that the combination of radiation, production of reactive groups and the ALD method enables selective doping of the material at predetermined points of the material. Radiation ensures the patterning and doping of exactly the desired point in the material. Furthermore, the use of the ALD method ensures an exact, predetermined increase in the thickness of the dopant layer. This achieves an exact method with no loss of dopant.

A further advantage of the method is that the selective doping of the material allows the characteristics of the material, for instance a porous glass material, to be changed in the desired manner by growing layers of a predetermined dopant to predetermined areas of the material. This enables the modification of the characteristics of the material and/or the product made thereof in the desired, predetermined manner.

A further advantage of the method is that the method enables the generation of an optical waveguide that has a predetermined shape and is in a three-dimensional state.

The use of the ALD method in the selective doping of a material is advantageous relative to prior art doping methods in that the ALD method enables the doping of a material prepared by any previously known method, such as the CVD (Chemical Vapour Deposition), OVD (Outside Vapor Deposition), VAD (Vapor Axial Deposition), MCVD (Modified Chemical Vapour Deposition), PCVD (Plasma Activated Chemical Vapour Deposition), DND (Direct Nanoparticle Deposition), the sol gel method or any other similar method, when required. In other words, materials prepared by known methods can be stored and, when necessary, treated in accordance with the present invention in order to produce the desired end product. A further advantage of the ALD method is that the method can be used for preparing materials doped with rare earth metals, particularly glass materials.

A further advantage of the invention is that the method of the invention is applicable to the manufacture of various products, such as optical waveguides.

### LIST OF FIGURES

In the following, the invention will be described in more detail by means of exemplary embodiments with reference to the accompanying drawing, in which

FIG. 1 shows the principle of selective radiation of a porous glass preform to be used in the manufacture of an optical fibre.

### DETAILED DESCRIPTION OF THE INVENTION

### Example 1

### Generating B₂O₃/SiO₂ Regions in a Fibre Preform

The functioning of the present invention, i.e. the use of a combination of radiation and the ALD method in selective doping of a material was studied by creating B₂O₃-doped regions in a porous glass preform used in the manufacture of an optical fibre. Regions produced with any other predetermined dopant can be created in a corresponding manner.

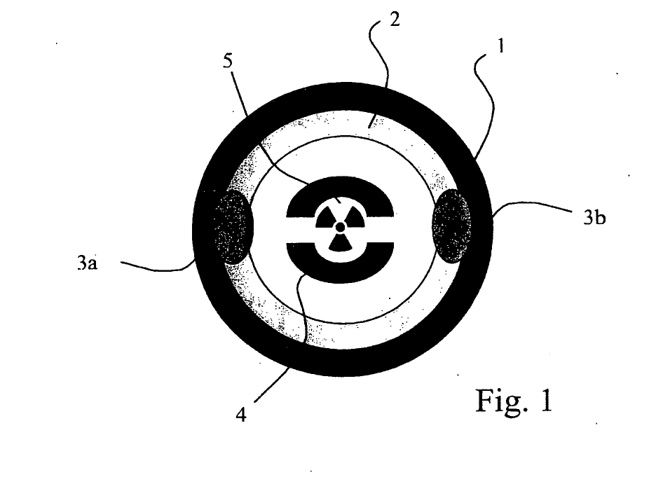

As is shown in FIG. 1, a silicon dioxide layer 2 was first generated in a conventional manner inside a silicon dioxide tube 1. A radiation source 5, protected with a radiation cover 4 such that only a predetermined part/area 3a,b of the porous silicon dioxide layer was radiated, was then introduced into the tube 1. The radiation source 5 was conveyed through the glass preform along its entire length.

After radiation, the porous glass preform was treated with hydrogen gas such that a region containing a plurality of hydroxyl groups was created on the surface thereof.

The porous glass preform was then introduced into an ALD reactor, wherein the B₂O₃ layers were grown. As parent substance of B₂O₃, the following substances, for example, may be used:

BX₃, wherein X is F, Cl, Br, I,

ZBX₂, Z₂BX or Z₃B, wherein X is F, Cl, Br, I and Z is H, CH₃, CH₃CH₂ or some other organic ligand, and

BX₃, wherein X is a ligand coordinated from oxygen or nitrogen, for example methoxide, ethoxide, 2,2,6,6-tetramethylheptanedione, acetylacetonate, hexafluoroacetylacetonate or N,N-dialkylacetamidinate.

As parent substances, different boranes BₓH_{y} or carboranes C_{z}BₓH_{y} may also be used. As examples, B₂H₆, B₄H₁₀, CB₅H₉ or derivatives thereof, such as different metallocarboranes, for instance [M(η⁵-C₅H₅)ₓ(C₂B₉H₁₁)], wherein M is a metal, may be mentioned.

In addition to the above, compounds wherein the ligands are combinations of the above, can be used.

In this experiment, (CH₃)₃B was used as the parent substance, and it reacted with the hydroxyl groups produced in the pre-treated region of the porous glass material.

The experiment showed that the dopant layer was created only exactly at the pre-treated area generated by radiation, and not in other points of the glass blank.

Finally, the ALD-doped porous glass preform was treated by conventional steps such that an optical fibre was produced from the selectively doped porous glass material.

The invention is not restricted only to the above-described exemplary embodiment, but various modifications are possible within the scope of the inventive idea defined in the claims.

1-30. (canceled)

31. A method of selective doping of a material, comprising
a) radiating a predetermined pre-treated pattern/region to the material,
b) treating the material for producing reactive groups to the pre-treated pattern/region, and
c) doping the material by the atomic layer deposition method for producing a pattern/region doped with a dopant to the material.

32. A method as claimed in claim 31, wherein radiating the predetermined pre-treated pattern/region in step a) to the material with ionizing radiation and/or non-ionizing radiation.

33. A method as claimed in claim 31, comprising treating the material with a gaseous and/or liquid substance in step b) to produce reactive groups.

34. A method as claimed in claim 31, comprising treating the material with a gas and/or liquid comprising hydrogen and/or a hydrogen compound in step b) to produce reactive groups.

35. A method as claimed in claim 31, comprising the reactive groups being OH groups, OR groups, SH groups and/or NH₁₋₄ groups.

36. A method as claimed in claim 31, comprising the dopant comprising one or more substances comprising a rare earth metal, a substance of the boric group, a substance of the carbon group, a substance of the nitrogen group, a substance of the fluoric group and/or silver.

37. A method as claimed in claim 31, comprising the material being glass, ceramic, polymer, metal and/or a composite thereof.

38. A method as claimed in claim 37, comprising the material being a porous glass material.

39. A method as claimed in claim 31, comprising controlling the intensity of one radiation beam or the intensity of two or more radiation beams at their point of intersection in a manner producing the predetermined pre-treated pattern/region.

40. A method as claimed in claim 31, comprising directing radiation in step a) from at least two different directions in a manner producing the pre-treated pattern in a three-dimensional state in the material.

41. A method as claimed in claim 40, comprising producing an optical waveguide in a three-dimensional state in the material.

42. A method as claimed in claim 31, comprising producing tension-generating regions in a porous glass preform used in the manufacture of an optical fibre.

43. A method as claimed in claim 31, comprising producing an optical waveguide on a plane surface.

44. A selectively doped material, wherein the material is produced by
a) radiating a predetermined pre-treated pattern/region to the material,
b) treating the material for producing reactive groups to the pre-treated pattern/region, and
c) doping the material by the atomic layer deposition method for producing a pattern/region doped with a dopant to the material.

45. A material as claimed in claim 44, wherein the predetermined pre-treated pattern/region is radiated in step a) with ionizing radiation and/or non-ionizing radiation.

46. A material as claimed in claim 44, wherein the material is treated with a gaseous and/or liquid substance in step b) to produce reactive groups.

47. A material as claimed in claim 44, wherein the material is treated with a gas and/or liquid comprising hydrogen and/or a hydrogen compound in step b) to produce reactive groups.

48. A material as claimed in claim 44, wherein the reactive groups are OH groups, OR groups, SH groups and/or NH₁₋₄ groups.

49. A material as claimed in claim 44, wherein the dopant comprises one or more substances comprising a rare earth metal, a substance of the boric group, a substance of the carbon group, a substance of the nitrogen group, a substance of the fluoric group and/or silver.

50. A material as claimed in claim 44, wherein the material is glass, ceramic, polymer, metal and/or a composite thereof.

51. A material as claimed in claim 50, wherein the material is a porous glass material.

52. A material as claimed in claim 44, wherein the intensity of one radiation beam or the intensity of two or more radiation beams are controlled at their point of intersection in such a manner that the predetermined pre-treated pattern/region is produced.

53. A material as claimed in claim 44, wherein radiation is directed in step a) from at least two different directions in such a manner that the pre-treated pattern to a three-dimensional state in the material is produced.

54. A material as claimed in claim 53, wherein the optical waveguide is produced to a three-dimensional state in the material.

55. A material as claimed in claim 44, wherein tension-generating regions are produced to a porous glass preform used in the manufacture of an optical fibre.

56. A material as claimed in claim 44, wherein an optical waveguide is produced on a plane surface.

57. A system for producing a selectively doped material as claimed in claim 44, wherein the system comprises:
a radiation source for radiating a predetermined pre-treated pattern/region to the material;
means for treating the material for producing reactive groups to the pre-treated pattern/region of the material, and
an atomic layer deposition device for doping the material with a dopant for producing a doped pattern/region to the material.

58. A system as claimed in claim 57, wherein radiation source comprises a source generating ionizing radiation and/or non-ionizing radiation.

59. A system as claimed in claim 57, wherein the system comprises at least two radiation sources for directing the radiation from at least two different directions.

60. A method of manufacturing optical fibre, optical plane waveguide and/or an optical waveguide in a three-dimensional state comprising the method of claim 31.
